(19) United States
(12) Patent Application Publication
(10) Pub. No.: US 2008/0055533 A1
(43) Pub. Date: Mar. 6, 2008

(54) Bonding structure of panel and back-plate

(76) Inventors: Kun-Hong Chen, Padeh City (TW); Huai-An Li, Padeh City (TW); Jiun-Ming Wang, Padeh City (TW); Yu-Hsien Chen, Padeh City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/602,227

(22) Filed: Nov. 21, 2006

(30) Foreign Application Priority Data
Aug. 29, 2006 (TW) 95131786

(51) Int. Cl. G02F 1/1333

(52) U.S. Cl. 349/158

(57) ABSTRACT

A bonding structure of panel and back-plate is made by coarsening the surface of the rear plane of silicon die, and then the LCoS panel may bond with the back-plate module more tightly. The coarse structure increases contact surface when bonding the back-plate module with the LCoS panel, as a result of increasing stickiness on both and reducing manufacturing process defects caused by position shifting between the back-plate module and LCoS panel, and solving the position problem before the bonding of the LCoS panel with the back-plate module.

### BACKGROUND OF THE INVENTION

1. Field of the invention

The present invention relates to a bonding structure of the panel and the back-plate, and more especially, relates to a bonding structure in liquid crystal on silicon (LCoS) panel.

2. Background of the related art

Nowadays, the Liquid Crystal on Silicon (LCoS) panel is the key technology of the reflective liquid crystal projector and the rear-projection television, the LCoS technology can dramatically reduce the panel production cost and the LCoS panel has great high resolution. To compare with the original liquid crystal display panel with two glass substrates, the upper substrate of the LCoS panel is glass, and the lower substrate is mainly made of silicon. As a result, the LCoS manufacturing technology integrates the liquid crystal display manufacturing technology to the complementary metal oxide semiconductor (CMOS) manufacturing technology.

The LCoS panel is a liquid crystal panel which is structure based on the silicon wafer, because of the rear plane of the LCoS panel is made of the plurality of metal oxide semiconductor (MOS) transistors instead of conventionally thin film transistor. And the pixel electrode is mainly made of metal material. Thus, the LCoS panel is one kind of reflective liquid crystal panel. Furthermore, due to the metal pixel electrode of the LCoS, especially the MOS transistor, in a pixel area is totally covered, as this result, the image display ability of the LCoS panel is greater than the conventional liquid crystal panel.

In conventional LCoS panel manufacturing, after LCoS panel is filled with liquid crystals and sealed out with glue, it is put on the back-plate module in right position. In the following process, a die bonding process, the LCoS panel is bonded to the back-plate module with a smooth surface, the back surface of the wafer, thus sometimes the bonding between the panel and the module is not solid. As a result, the die will easily shift away from the position on the back-plate module in the bonding process, and the rework process after die bonding is necessary. Even worse, the LCoS panel may be damaged or discarded.

### SUMMARY OF THE INVENTION

In order to solve the problems mentioned above, the present invention provides a silicon wafer has a coarse structure surface. Wherein, the coarse structure is made by semiconductor manufacturing processes to form an indentation on the back surface, and a boss is formed on the surface of the back-plate module to match with the indentation precisely to improve the positioning accuracy of the LCoS panel. Thus the coarse structure enlarges the contact area between the LCoS panel and the back-plate module and enhances the bonding strength.

In order to solve the problems mentioned above, the present invention provides a die bonding structure of a panel and a back-plate module. The back surface of die has a coarse structure, wherein the coarse structure increases the friction of the contact area between LCoS panel and the back-plate module, thus the coarse structure can enhance the bonding strength and avoid breaking the wires on the chip when the sequential processes continue.

To achieve these and other advantages as embodied and broadly described, in accordance with the purpose of the present invention, a bonding structure of panel and back-plate as a component of a projector is provided. The bonding structure includes a LCoS panel including a glass layer, a silicon layer, and liquid crystals filled between the glass layer and the silicon layer, wherein the back surface of the silicon layer has a coarse structure, and a back-plate module bonded to the back surface of the silicon layer.

Additionally, one embodiment of the present invention provides a bonding structure of a panel and a back-plate as a component of a projector including a LCoS panel including a glass layer, a silicon layer, and liquid crystals filled between the glass layer and the silicon layer, wherein a back surface of the silicon layer at least has an indentation, and a back-plate module having a surface, disposed of a boss, bonded to the back surface of the silicon layer, wherein the boss matches with the indentation for precisely positioning the LCoS panel on the back-plate module.

### BRIEF DESCRIPTION OF THE DRAWINGS

FIG. 1 is a sectional view illustrating a bonding structure of panel and back-plate in accordance with an embodiment of the present invention.

FIG. 2a is a top view diagram illustrating a back surface of silicon wafer in LCoS panel in accordance with an embodiment of the present invention.

FIG. 2b is a top view diagram illustrating a coarse structure of the back surface of silicon wafer in LCoS panel in accordance with FIG. 2a.

FIG. 3 is a top view diagram illustrating a coarse structure of the back surface of one die in LCoS panel of FIG. 2b in accordance with an embodiment of the present invention.

FIG. 4 is a cross-sectional view diagram illustrating a coarse structure on the back surface of silicon wafer in accordance with an embodiment of the present invention.

FIG. 5 is a cross-sectional view diagram illustrating a coarse structure on the back surface of silicon wafer in accordance with an embodiment of the present invention.

FIG. 6 is a cross-sectional view diagram illustrating a coarse structure on the back surface of silicon wafer in accordance with an embodiment of the present invention.

FIG. 7 is an explored sectional view illustrating a bonding structure of panel and back-plate with a back-plate module according to one embodiment of the present invention.

### DETAILED DESCRIPTION OF THE INVENTION

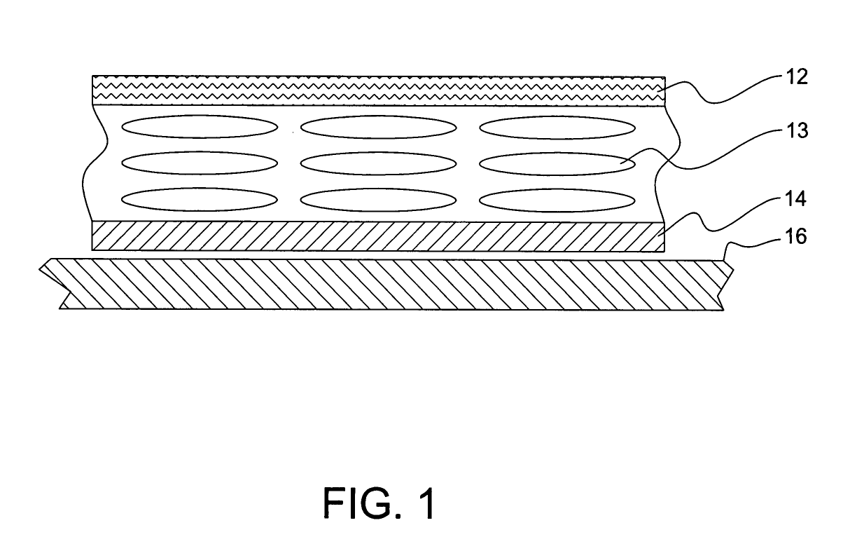

FIG. 1 illustrates a bonding structure of panel and back-plate in accordance with an embodiment of the present invention. The LCoS panel has one glass layer 12 and one silicon layer 14 on both sides respectively. After the back-plate module 16 is glued to the back surface of the silicon layer 14 to complete the seal work, and liquid crystals 13 are filled between the glass layer 12 and the silicon layer 14. Thus, the die bond process is complete.

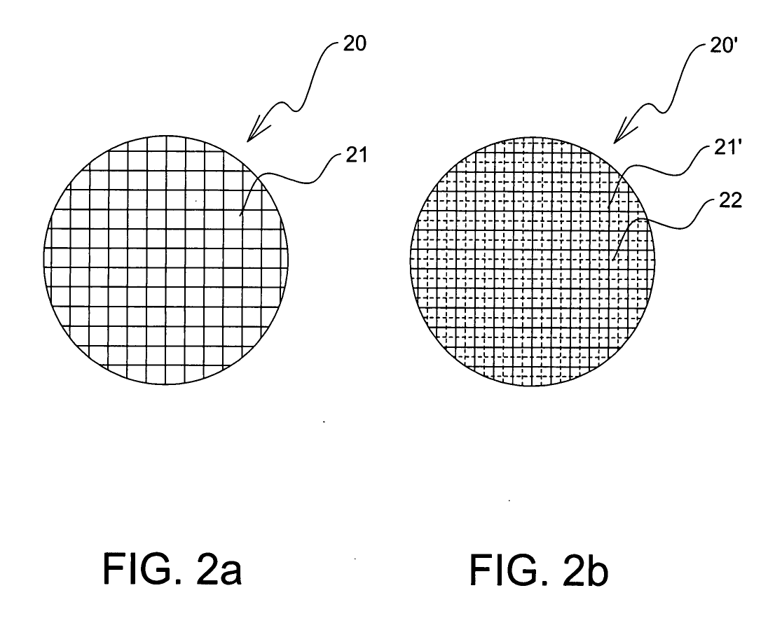

FIG. 2a is a top view diagram illustrating a back surface of silicon wafer in LCoS panel in accordance with an embodiment of the present invention. The silicon wafer 20 is a substrate used in LCoS panel, and the back surface of the silicon wafer 20 has a grid of trenches 21 about 500 μm deep for cutting the silicon wafer 20 to many separate dies.

FIG. 2b is a top view diagram illustrating a coarse structure of the back surface of silicon wafer in LCoS panel in accordance with FIG. 2a. A coarse structure, a grid of trenches 21′ cutting the silicon wafer, and a grid of indented lines 22 are on the back surface of the silicon wafer 20′. The indented lines 22 are made by laser cutting about 100 μm to 200 μm in depth to form a coarse surface on the back surface of silicon wafer 20′, thus when the back-plate module (not shown) is bonded to the LCoS panel, the bonding strength between them will be enhanced by those dies to prevent position shift. Additionally, the grid of trenches 21′ may have different patterns on the back surface of the silicon wafer 20′, for example, the indented lines 22 cross the grid of trenches 21′ with an oblique angle.

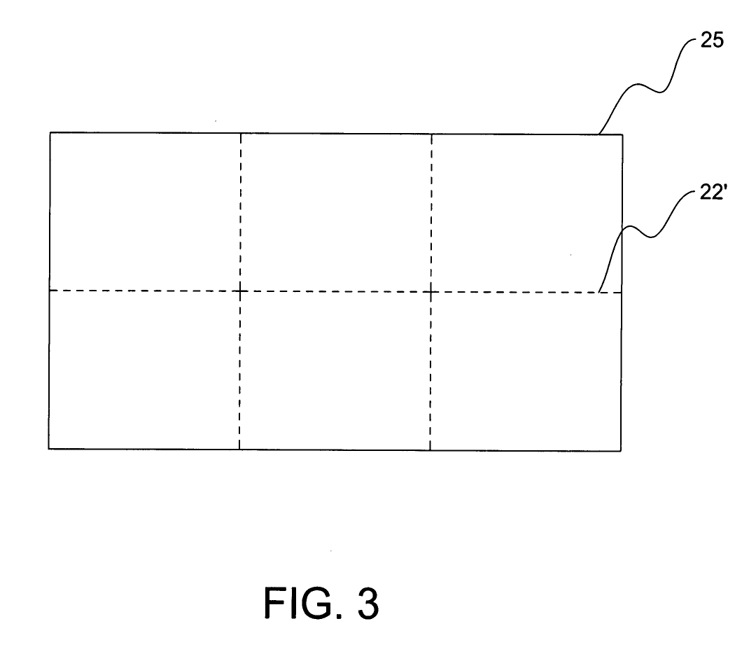

FIG. 3 is a top view diagram illustrating a coarse structure of the back surface of one die in LCoS panel of FIG. 2b in accordance with an embodiment of the present invention. After the silicon wafer is cut across the trenches, the indented lines 22′ forms a coarse structure on a single die 25.

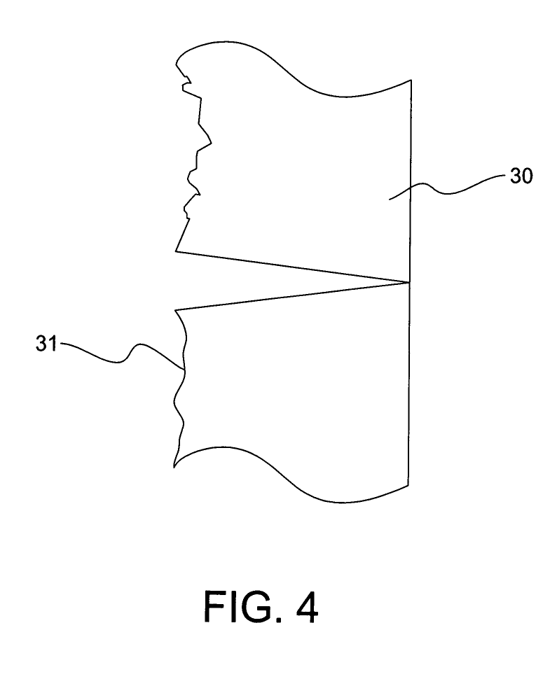

FIG. 4 is a cross-sectional view diagram illustrating a coarse structure on the back surface of silicon wafer in accordance with an embodiment of the present invention. The coarse structure is an indentation 31 on the back surface of silicon wafer 30. In addition, the indentation 31 may be a recess grinded by a grinder using the abrasive solvent with 100 μm to 200 μm diameter.

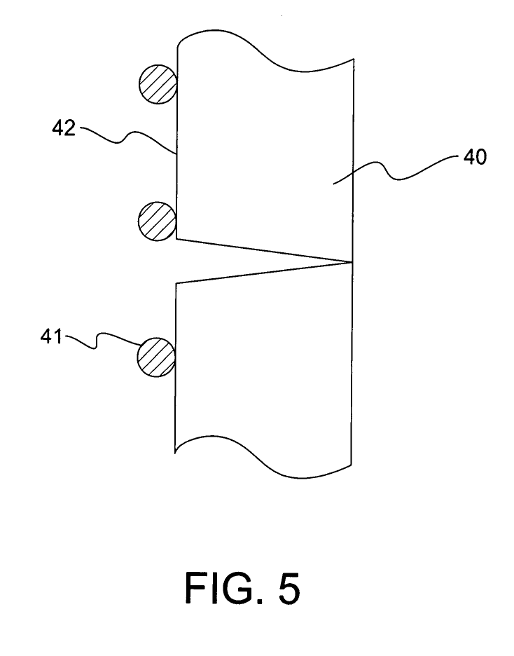

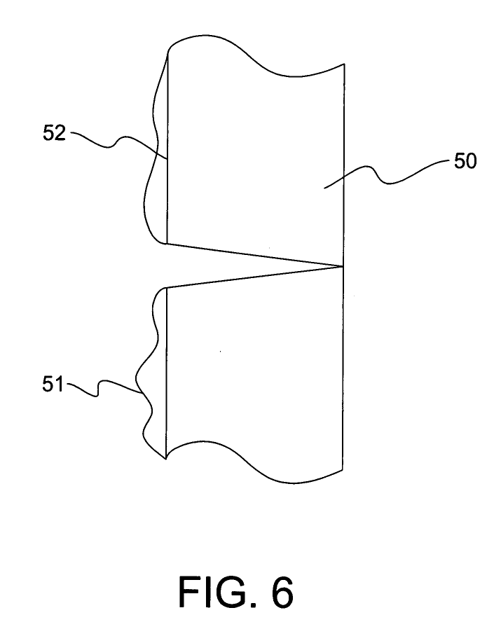

Furthermore, the coarse structure on the back surface of the silicon wafer is higher than the back surface of the silicon wafer. The coarse structure is some non-metal particles 41 sprayed on the back surface 42 of the silicon wafer 40 illustrated in FIG. 5. In another embodiment, the coarse structure may be a polymer solvent 51 inject-printed on the back surface 52 of the silicon wafer 50 with a given pattern illustrated in FIG. 6.

The coarse structure may be some photo-resist spread on the back surface by using photolithography. The coarse structure also could be the polymer solvent printed on the back surface with a specific pattern by using screen-printing.

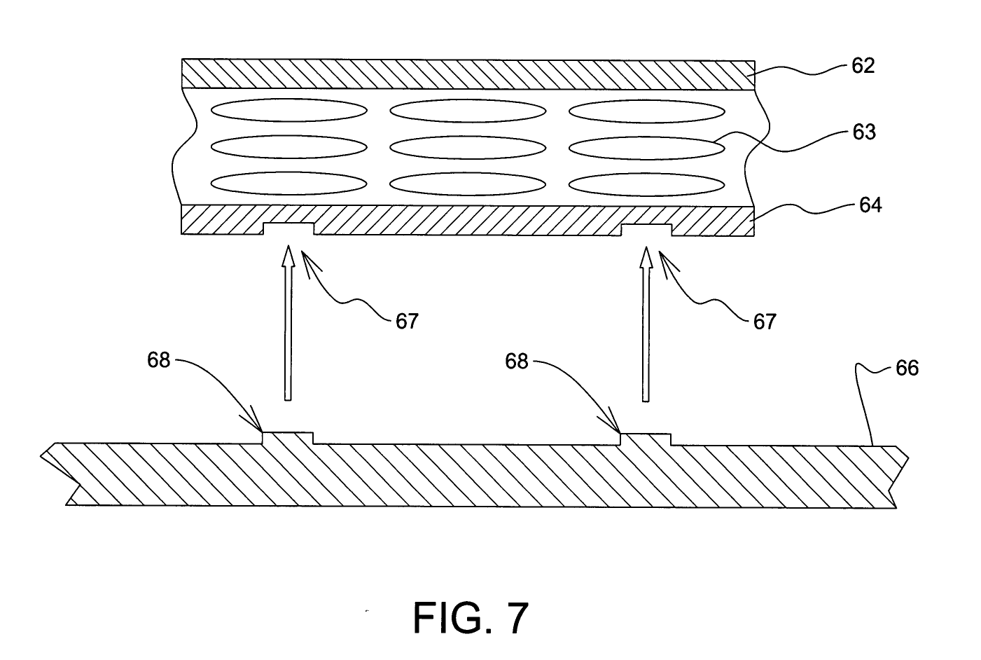

FIG. 7 illustrates a bonding structure of a panel and a back-plate module according to one embodiment of the present invention. The bonding structure is a component of a projector and the bonding structure includes a LCoS panel including a glass layer 62, a silicon layer 64, and liquid crystals 63 filled between the glass layer 62 and the silicon layer 64, wherein the back surface of the silicon layer 64 has a plurality of lower indentations 67 configured on the back surface of the silicon layer 64, and a back-plate module 66 having some bosses 68 disposed on its surface bonded to the back surface of said silicon layer 64, wherein the bosses 68 matches with the indentation 67 for precisely positioning the LCoS panel on the surface of the back-plate module 66.

Accordingly, those dies are produced by cutting the wafer across the trenches. And the indented lines form a coarse surface on the back of die in FIG. 3.

Accordingly, the coarse structure on the back surface of wafer gets a more contact area than that a smooth surface does. As a result, the strength of die bond between the LCoS panel and the back-plate module will be enhanced to solve the position shift problem in sequential processes. Consequently, the rework process of bonding the LCoS panel to the back-plate module can be avoided; sometimes the rework process may damage the LCoS panel wiring, rise up the cost and waste the labor effort.

Although the present invention has been explained in relation to its preferred embodiment, it is to be understood that other modifications and variation can be made without departing the spirit and scope of the invention as hereafter claimed.

What is claimed is:

1. A bonding structure of panel and back-plate, comprising:
a liquid crystal on silicon panel comprising a glass layer, a silicon layer, and a plurality of liquid crystals filled between said glass layer and said silicon layer, wherein a back surface of said silicon layer has a coarse structure; and
a back-plate module bonded to said coarse structure.

2. The bonding structure of panel and back-plate according to claim 1, wherein said coarse structure is a polymer solvent inject-printed on said back surface to form some patterns.

3. The bonding structure of panel and back-plate according to claim 1, wherein said coarse structure is a plurality of non-metal particles sprayed on said back surface.

4. The bonding structure of panel and back-plate according to claim 1, wherein said coarse structure includes photo-resist spread on said back surface by using photolithography.

5. The bonding structure of panel and back-plate according to claim 1, wherein said coarse structure is a polymer solvent printed on said back surface to form some pattern by using screen-printing.

6. The bonding structure of panel and back-plate according to claim 1, wherein said coarse structure is an indentation on said back surface, and said indentation is lower than said back surface.

7. The bonding structure of panel and back-plate according to claim 6, wherein said indentation is carved by laser cutting.

8. The bonding structure of panel and back-plate according to claim 6, wherein said indentation is grinded by a grinder using an abrasive solvent.

9. A bonding structure of panel and back-plate as a component structure of a projector, said bonding structure of panel and back-plate comprising:
a liquid crystal on silicon panel comprising a glass layer and a silicon layer, a plurality of liquid crystals filled between said glass layer and said silicon layer, wherein a back surface of said silicon layer at least has an indentation; and
a back-plate module having a surface disposed of boss, said surface bonded to said back surface of said silicon layer, wherein said boss matches with said indentation for precisely positioning said liquid crystal on silicon panel on said back-plate module.

10. The bonding structure of panel and back-plate according to claim 9, wherein said indentation is carved by laser cutting.
